(19) United States
(12) Patent Application Publication
(10) Pub. No.: US 2012/0227474 A1
(43) Pub. Date: Sep. 13, 2012

(54) DEVICE COMPRISING A RESONATOR FOR DETECTING AT LEAST ONE SUBSTANCE OF A FLUID, METHOD FOR PRODUCING SAID DEVICE AND METHOD FOR DETECTING AT LEAST ONE SUBSTANCE OF ANOTHER FLUID

(76) Inventors: Martin Nirschl, Traunstein (DE); Matthias Schreiter, Munchen (DE); Daniel Sickert, Nurnberg (DE)

(21) Appl. No.: 13/499,229

(22) PCT Filed: Sep. 20, 2010
(86) PCT No.: PCT/EP2010/063793

§ 371 Date: May 24, 2012

(30) Foreign Application Priority Data
Sep. 30, 2009 (DE) 102009047905.8

(51) Int. Cl. G01N 29/02

(52) U.S. Cl. 73/61.79

(57) ABSTRACT

A device for detecting a substance of a fluid or the concentration of a substance of a fluid may include a carrier to which a resonator is applied, to which a chemically sensitive material for adsorption of a substance to be detected is applied. The adsorption of the substance increases the mass of the resonator. The concentration of the substance in the liquid can be determined by measuring the frequency change of the resonator.

### CROSS-REFERENCE TO RELATED APPLICATIONS

This application is a U.S. National Stage Application of International Application No. PCT/EP2010/063793 filed Sep. 20, 2010, which designates the United States of America, and claims priority to DE Patent Application No. 10 2009 047 905.8 filed Sep. 30, 2009. The contents of which are hereby incorporated by reference in their entirety.

### TECHNICAL FIELD

This disclosure relates to a device for detecting at least one substance of a fluid, a method for producing this device and a method for detecting at least one substance of another fluid.

### BACKGROUND

In the Chemical or Pharmaceutical Industries, it is often important to perform detections of a substance in a fluid with a small sample quantity and a high throughput.

Hitherto, it has been possible to observe and monitor the application of minute quantities in the order of magnitude of nanoliters of the liquids to be detected in a label-free manner, for example with a quartz crystal microbalance or SPR (surface plasmon resonance). These techniques often have the drawback that they require a large area and space and therefore are difficult to integrate in other applications, such as, for example, systems for handling minute quantities of liquid.

A further possibility consists in applying a label to the substance to be detected. This label has the property of being substantially easier to detect than the actual substance to be measured, for example due to special detectable properties such as fluorescence or radioactivity. A commercially successful example of this is ELISA.

This solution often has the drawback that the substance to be measured is only measured indirectly, that is via the presence of the label. This typically makes the measurement less precise and subject to a high degree of error. In addition, it is not possible to observe any reaction of the substance with the surface or a biochemical component on the surface in real time. This is necessary in pharmaceutical development, for example.

Techniques with which small quantities of substance in solution can be applied approximately in the range from picoliters to nanoliters to surfaces, for example, are known. For example “pin and ring coaters” or “ink-jet printers”.

Biosensors are being used to an increasing extent in modern biological analysis technology and in medical diagnostics. A biosensor consists of a biological detection system for a biological substance and a so-called physical transducer. The substance is “detected” by the biological detection system. This “detection” is converted into an electronic signal by means of the physical transducer. Frequently used biological detection systems are antibodies, enzymes and nucleic acids. In this case, the biological detection systems are generally immobilized (fixed) on the transducer in approximately two-dimensional layers. Immobilization (fixation) can be effected in this case by means of covalent bonds, by affinity interactions and by hydrophilic or hydrophobic interactions. An overview of a structure consisting of approximately two-dimensional biological detection layers is given by I. Willner and E. Katz in “Angewandte Chemie” (Applied Chemistry), 112 (2000), pp 1230 to 1269.

A device and a method of the type cited in the introduction is known from U.S. Pat. No. 5,932,953 or from C. Köβlinger et al., Biosensors & Bioelectronics, 7 (1992), pp 397 to 404. The device and the method can also be found in EP 1143241 A1. The surface section of the resonator constitutes a detection system for a substance. The piezoelectric resonator acts as a physical transducer. The piezoelectric layer of the known resonator consists of a quartz crystal. Gold electrodes are attached to the quartz crystal. The quartz crystal is excited by electrical actuation of the electrodes to produce bulk acoustic waves in form of thickness shear mode oscillations. The resonance frequency is about 20 MHz. One of the electrodes forms the surface section used for sorption of the substance of the fluid. The substance is a macromolecular protein which is present in a liquid and which is physically adsorbed on the electrode. As a result of the adsorption of the protein, there is a change in the mass and hence the resonance frequency of the resonator. The following general relationship applies to the change in the resonance frequency (Δf) as a function of the change in the adsorbed quantity of the substance per unit area (Δm) (see G. Sauerbrey, Zeitschrift für Physik (Journal for Physics), 155 (1959), pp 206-222):

S=Δf/Δm=c*f0/m≈f0²

Here, S is the mass sensitivity of the resonator, f0 is the resonance frequency of the resonator without adsorbed substance, c is a material-specific constant and m is the mass of the resonator per unit area. The mass sensitivity is proportional to the square of the resonance frequency of the resonator. At a relatively low resonance frequency f0 of about 20 MHz, the mass sensitivity of the known device can be estimated to be about 1 Hz·ng-l·cm2.

The known resonator has a surface section on which a substance can be sorbed. To this end, the resonator has a chemically sensitive coating forming the surface section. The adsorption causes a change in the mass of the resonator. As a result of this, there is a change in the resonance frequency of the resonator. The extent of the change in the resonance frequency is dependent upon the adsorbed quantity of the substance. The more substance is adsorbed, the greater the change in the resonance frequency.

A piezoelectric resonator is known from DE 10308975 B4 in which the resonance frequency changes when a fluid with substances is applied to the surface of the resonator and adsorbed by the resonator surface. The technology used to construct the resonator is also known as a “film bulk acoustic wave resonator” (FBAR).

### SUMMARY

In an embodiment, a device for detecting at least one substance of a fluid or the concentration of a substance of a fluid comprises a carrier, a resonator applied to the carrier, which on its surface facing away from the carrier with a comprises a relevant surface section for at least partially receiving the substance to be detected, wherein the surface of the resonator facing the fluid and/or the relevant surface section has a higher affinity for the fluid than the surface surrounding the resonator or the area surrounding the relevant surface section, and/or a barrier surrounding the resonator to prevent the fluid flowing off from the resonator is applied to the carrier, wherein the barrier (4) together with the surface of the resonator encloses at least one volume for completely receiving the fluid, wherein the barrier ideally has a lower affinity for the fluid than the surface of the resonator and is preferably made of a polymer or photo-resist.

In a further embodiment, the surface of the resonator with a first layer for receiving the material forming the relevant surface section is coated by deposition of the material from a fluid, wherein the material for receiving a substance to be detected is applied to the first layer of the material, wherein a further fluid can be applied with the substance to be detected to the material. In a further embodiment, the resonator can be excited by an electric alternating field and is preferably embodied as a film bulk acoustic wave resonator (FBAR) and preferably a piezoelectric element is provided as an active element of the resonator, wherein the alternating field preferably contains a plurality of frequencies in the range of the resonance frequency simultaneously. In a further embodiment, an evaluation unit for the electric actuation of the resonator and for measuring the respective current resonance frequency is present, wherein the resonance frequency of the device is continuously excited. In a further embodiment, the liquid volume that can be applied to the surface of the resonator is between 0.1 and 10 nanoliters, preferably about 1 nanoliter. In a further embodiment, a plurality of resonators are arranged in a row or in an array arrangement next to each other.

In another embodiment, a method for producing the device as disclosed above is provided, wherein a fluid containing the material is applied to the surface of the resonator facing the fluid and/or to the relevant surface section, the material is at least partially deposited on the surface and/or the relevant surface section, the quality the surface and/or of the relevant surface section and of the deposited material following the application of the fluid is determined by measuring the deviation of the displacement of the resonance frequency and/or by measuring the deviation of the displacement of the temporal course of the resonance frequency from a preset set point or set course.

In a further embodiment the resonance frequency before the application of the fluid is also used to evaluate the quality. In a further embodiment, after the detection of a sufficient quality, the fluid is removed, e.g., by evaporation or by mechanical aids so that the device is ready for the method as claimed in any one of the following claims.

In another embodiment, a method is provided for detecting at least one substance of another fluid or a reaction product of the further fluid with the aid of a device as disclosed above, wherein the further fluid is applied to the surface of the resonator facing the fluid or the relevant surface section, at least one of the further substances or the reaction product or the concentration of the at least one of the further substances or of the reaction product or the temporal course of the deposition of the further substance or of the reaction product to the surface or the relevant surface section after the application of the further fluid is determined by measuring the deviation of the displacement of the resonance frequency and/or by measuring the deviation of the displacement of the temporal course of the resonance frequency from preset reference values or set course.

In a further embodiment, the volume of the further fluid applied corresponds to a preset reference value, wherein the reference value is preferably between 0.1 and 10 nanoliters. In a further embodiment, the fluid or the further fluid completely covers the cross section of the surface of the resonator. In a further embodiment, a plurality of fluid layers are applied one on top of the other to the resonator, in that a dispenser applies a first fluid in a first step and a further fluid in a step or a plurality further steps so that the fluid types are completely mixed so that reaction products, reaction times and/or the mixing product and/or the concentration thereof can be determined.

### BRIEF DESCRIPTION OF THE DRAWINGS

Example embodiments will be explained in more detail below with reference to figures, in which:

FIGS. 1A, 1B, and 1C illustrate an example device for detecting a substance of a fluid before, during and after the last production step in each case in side view, according to an example embodiment.

FIGS. 2A and 2B illustrate an example device for detecting a substance of a fluid from FIG. 1C in a further variant in side view and top view, according to an example embodiment.

FIGS. 3A and 3B illustrate the example device for detecting a substance of a fluid from FIG. 2 in two successive measuring situations in side view, according to an example embodiment.

FIG. 4 illustrates the example device for detecting a substance of a fluid from FIG. 2 in a further measuring situation in side view, according to an example embodiment.

FIG. 5 illustrates an array comprising a plurality of devices from FIG. 1C arranged next to one another, according to an example embodiment.

FIG. 6 illustrates measuring results from the determination of the concentration of immunoglobin in a liquid with the aid of the devices shown in FIG. 1C, according to an example embodiment.

### DETAILED DESCRIPTION

Sorption should be understood to mean the formation of a chemical or physical bond between the substance to be detected and a relevant surface section of the resonator described in more detail below. In this context, sorption includes both absorption and adsorption. With absorption, the substance is absorbed for example through a coating of the resonator, which forms the surface section without the formation of a phase boundary. The substance is incorporated into the coating. On the other hand, with adsorption, a phase boundary is formed.

Conceivable in particular in this case is adsorption in the form of physisorption. The substance is deposited on the surface section of the resonator by Van the Waals or dipole-dipole interactions. Alternatively, adsorption can take place in the form of chemisorption. With chemisorptions, the substance is deposited on the surface section with the formation of a chemical bond. The chemical bond is, for example, a covalent bond or a hydrogen bridge bond. The above-described deposition of the material to be detected/or the substance to be detected on the relevant surface section of the resonator described in more detail below can also take place by means of other binding mechanisms, for example deposition by utilizing the gravity acting on the substance.

Preferably, the sorption takes place as a reversible process. This means that the substance can also be desorbed (removed) from the surface section. For example, the substance is removed again by increasing the temperature of the surface section or by the action of a reactive material. The reactive material is, for example, an acid or an alkali by means of which the bonds formed by chemisorption are dissolved. This enables the device to be used a number of times. However, it is also possible for the sorption to be irreversible. As a single-use sensor the device is only used once.

Affinity should be understood to mean the driving force of a chemical reaction, namely the attempts of ions, atoms or groups of atoms to form a covalent bond. A surface or a material with high affinity for a fluid applied thereto is also referred to as homophilic. A surface or a material with low affinity for a fluid applied thereto is also referred to as heterophilic. The fluid spreads over a highly homophilic surface over its whole surface, while, on a highly heterophilic surface, it preferably contracts to form one or more spherules.

The fluid mentioned below is, for example, an aqueous solution or a hydrocarbon-based solvent. Every conceivable chemical or biological compound can be used as the substance. Substances of this kind are, for example, organic solvents. It is also conceivable for such a substance to be an explosive or a component, primary product or breakdown product of an explosive. The device can be used as an explosives detector. It is also conceivable for the device to be embodied as a biosensor for the detection of any desired biomolecule. The biomolecule is for example a DNA (deoxyribonucleic acid) sequence or a macromolecular protein.

The surface section may be embodied in such a way that a specific substance or substance class is sorbed selectively according to the key-lock principle and thus detected. Hence, it is possible, to use the device to detect a specific substance selectively from a mixture of a plurality of substances. In this case, the detection comprises both a qualitative and a quantitative determination of the substance. The absence or presence of the substance in the fluid can be proven. It is also possible to determine the concentration of the substance in the fluid. A temporal change in the concentration of the substance can also be determined by differential detection of the substance. Hence, the device is also suitable, for example, for reaction monitoring of a chemical reaction in which the substance is involved.

In particular, the chemically sensitive coating has molecules for detecting the substance. For the detection of a specific DNA sequence, such molecules are appropriate oligonucleotides (DNA oligos) including a plurality of nucleotide units.

In this case, the molecules for detecting the substance can be directly coupled to a transducer surface. The transducer surface is a gold electrode of the resonator, for example. Molecules that have a thiol group are attached directly to the transducer surface by the formation of a gold sulfur bond.

In one embodiment, the chemically sensitive coating has an immobilization layer for connecting the resonator and the molecules for detecting the substance. For example, a transducer surface has NH or OH groups. In this case, the molecules for detecting the substance can be immobilized by means of alkoxysilanes, cyanuric chloride or carbodiimide. These compounds form the immobilization layer.

The immobilization layer can be directly coupled to the transducer surface. It is also conceivable for the immobilization layer to be indirectly coupled to the transducer surface via an adhesion promoter layer.

The immobilization layer can be substantially two-dimensional. The immobilization layer is arranged as an ordered monomolecular or multimolecular layer along the transducer surface. In particular, however, the immobilization layer is three-dimensional. An immobilization matrix is present. For example, the immobilization layer has open pores in which the molecules for detecting the substance are arranged. A chemically sensitive coating with a large “reactive” surface is present. As a consequence, a chemically sensitive coating with a three-dimensional immobilization layer is characterized by increased mass sensitivity for the detection of the substance. The three-dimensional immobilization layer can, for example, be generated by radical crosslinking of monomers. The molecules for the detection of the substance can be bonded to the crosslinked monomers. It is also conceivable for the monomers already to have the functional groups for the detection of the substance prior to the crosslinking.

The oscillation of the resonator is selected in particular from the longitudinal oscillation group and/or thickness shear mode oscillation group. The type of oscillation excited depends, among other factors, on a symmetry group of the piezoelectric material, the orientation of the piezoelectric layer toward the surface and the arrangement of the electrodes. The piezoelectric layer includes, for example, of a <111>-oriented plumbum zirconate titanate. If an electric field is applied only in the z-direction along the layer thickness of the piezoelectric layer, this results primarily in a longitudinal oscillation along the layer thickness. With the arrangement described, on the other hand, the thickness shear mode oscillation can occur along the lateral extension of the piezoelectric layer. However, in order to effect this, the thickness shear mode oscillation requires a lateral component of the exciting electric field. The longitudinal oscillation is used in particular for investigating a gaseous fluid. In the case of a liquid fluid, the longitudinal oscillation is relatively strongly attenuated, resulting in a substantial reduction in the mass sensitivity. In order to investigate a liquid fluid using the longitudinal oscillation of the resonator, the fluid is therefore removed from the surface section or from the resonator after the sorption. The measurement of the resonance frequency of the resonator takes place after the sorption in the absence of the fluid. On the other hand, the measurement of the thickness shear mode oscillation is suitable for the direct investigation of a liquid fluid. The thickness shear mode oscillation is only attenuated to an imperceptible degree in a liquid. The measurement can be taken when the resonator comes in contact with the liquid.

The quality of surface facing the fluid surface with the coating and the chemically-sensitive material influences the quality of the measuring device. Quality factors are uniform thickness and/or the covering of the layer on the resonator and uniform thickness or covering of the chemically sensitive material on the layer.

The following describes protein detection:

A chemically sensitive coating formed from an oligonucleotide consisting of 25 bases is immobilized on the gold electrode of the piezoacoustic resonator. The oligonucleotide is applied to the electrode as an aqueous solution with a concentration of a few mmol in the sub-nanoliter range. Each of the oligonucleotides has a thiol-alkyl group at the 3′ position and a biotin group at the 5′ position. Sulfur-gold bindings are formed via the thiol-alkyl group. The oligonucleotides are immobilized on the electrode. The basic oligonucleotide structure forms a kind of immobilization layer. The biotin group forms a strong complex with streptavidin. The biotin group acts in a way as a molecule for detecting the substance streptavidin. As soon as this protein is present in a fluid to which the described chemically sensitive coating is exposed, complex formation takes place resulting in the sorption of the protein on the chemically sensitive coating.

The following describes DNA detection:

Oligonucleotides consisting of 25 bases are immobilized via thiol-alkyl groups. The oligonucleotides have no biotin groups. DNA fragments containing a correspondingly complementary nucleotide sequence are bonded to the immobilized oligonucleotides through the formation of hydrogen bridge bonds.

The device for detecting at least one substance of a fluid or the concentration of a substance of a fluid comprises a carrier to which an acoustic resonator is applied, which is coated on its surface facing away from the carrier with a first layer for receiving a material, wherein the first layer is made of gold, for example. A further fluid containing the material is applied to the first layer. The material can be chemically sensitive, specifically selective or unselective and/or capable of sorbing a substance to be detected or a reaction or mixing product. Alternatively, the material can be capable of receiving sediments or deposits of the elements named above. The material is deposited on the first layer. The deposition process can be measured by continuously measuring the change in the resonance frequency, since the mass on the surface of the first layer increases.

The surface of the resonator facing the fluid may already directly comprise a layer or a relevant surface section for receiving a substance to be detected and/or reaction or mixing product to be detected or the relevant surface section. The acoustic resonator, e.g., embodied as a piezoelectric element, is excited by electric energy and may be embodied as a film bulk acoustic wave resonator (FBAR).

The resonator can be excited by an electric alternating field and may be embodied as a film bulk acoustic wave resonator (FBAR) with a piezoelectric element as an active element of the resonator. The alternating field may comprise a plurality of frequencies in the range of the resonance frequency simultaneously, as a result of which the resonance frequency of the device is continuously excited. Consequently, the evaluation unit for the electric actuating of the resonator and for measuring the resonance frequency is able to measure these with virtually no delay. The evaluation unit is present on either the carrier or externally.

The liquid volume that can be applied to the surface of the resonator with the aid of a dispenser may be between 0.1 and 10 nanoliters.

The surface of the resonator facing the fluid may have a higher affinity for the fluid than the surface surrounding the resonator horizontally, for example the surface is made of gold and the surrounding surface of silicon dioxide (SiO₂). The height of the resonator is usually a few μm.

A barrier applied to the carrier may surround the resonator to prevent the fluid flowing off the resonator, wherein the barrier together with the surface of the resonator encloses at least one volume for completely receiving the fluid applied. In this case, the barrier may have a lower affinity for the fluid than the surface of the resonator and may be made of a polymer or photo-resist.

A plurality of resonators may be arranged in a row or in an array arrangement next to each other so that a plurality of sensor elements is available for each carrier unit.

The sensor may be produced by applying a fluid containing a chemically sensitive material to the first layer of the resonator, wherein the material is at least partially deposited on the first layer. In this case, the quality of the first layer and of the deposited material can be measured after the application of the fluid to the first layer in that the deviation of the displacement of the resonance frequency from a reference value is determined. The reference value is, for example, the resonance frequency of the resonator coated with a reference liquid containing no substances. Continuous measurement of the deviation of the displacement of the temporal course of the resonance frequency from a preset set point or set course also enables the quality the deposition to be determined.

Following the detection of a sufficient quality of the sensor, the fluid (3) is removed by evaporation or by mechanical aids so that the device is ready for the measuring procedure described below.

The fluid may completely cover the cross section of the surface of the resonator.

The method for detecting at least one substance of a fluid with the aid of the sensor described above may be performed by applying the fluid containing one or more further substances to the chemically-sensitive material. The adhesion of the substance to be detected to the chemically-sensitive substance increases the mass of the resonator. Measuring the displacement of the resonance frequency as a function of time enables the concentration of the substance to be determined. The temporal course of the deposition of the substance on the chemically-sensitive material can be determined after the application of the further fluid on the material by measuring the deviation of the displacement of the resonance frequency. In this case, the measured values are compared with reference values in order to be able to estimate the measuring tolerances.

A plurality of fluid layers may be applied to the resonator one on top of the other in that a dispenser applies a first fluid in a first step and a further fluid in a step or a plurality of further steps so that the fluid types (32, 33) are mixed. An advantage of the application of preset volumes of the corresponding fluid types in each case is that a precise mixing ratio can be set without the need for the usual premixing of fluid types in microfluidic technology being necessary. This enables the fully automatic setting of a broad range of concentrations. Moreover, this procedure also enables more than two different fluid types to be applied one on top of the other thus achieving a wide range of mixing combinations.

2A3A1C The fluid 3, 31, 32, 33 shown in the figures may be, for example, an aqueous solution or a hydrocarbon-based solvent.

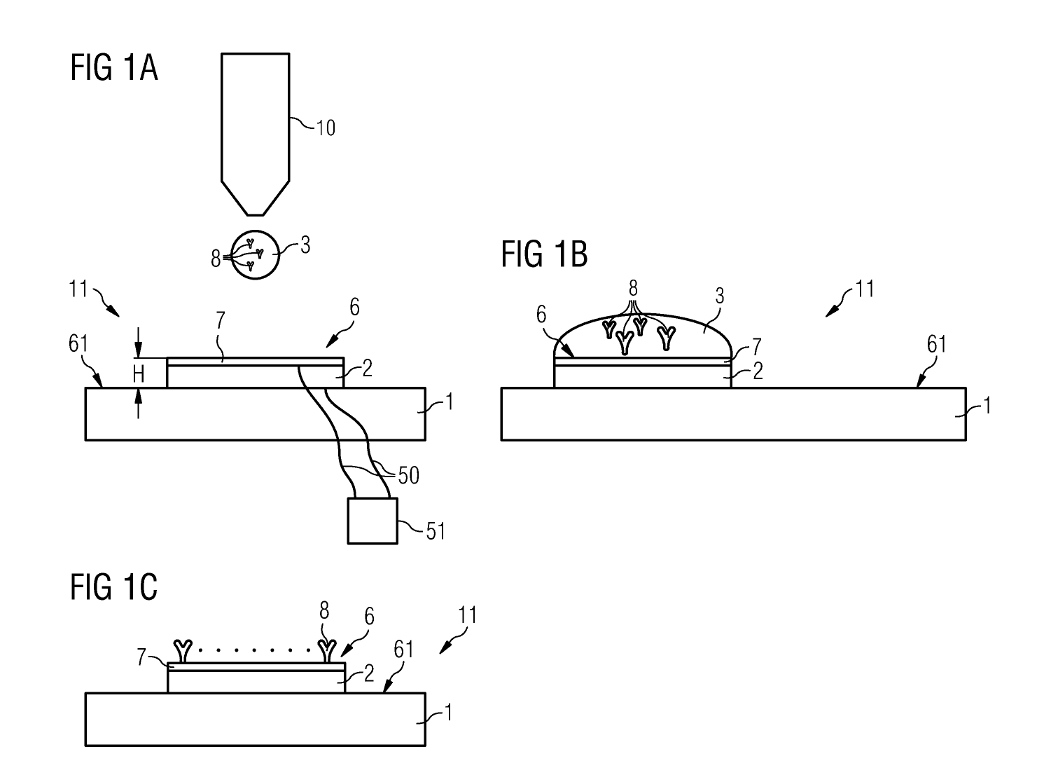

FIGS. 1A, 1B, and 1C show a device 11 for detecting a substance of a fluid before, during and after the last production step, each in side view. In this case, the device is for example a biosensor for detecting biomolecules. The biomolecules are, for example, oligonucleotides. Alternatively, biomolecules in the form of proteins are detected.

FIG. 1A shows a carrier 1 on which an acoustic resonator 2 is applied, which is coated on its end face 6 facing away from the carrier 1 with a first layer 7 for receiving a chemically-sensitive material 8. The first layer is, for example, made of gold 7 or from a material able to bond a chemically-sensitive material 8 uniformly firmly. The layer can alternatively also be embodied as an immobilization layer. A fluid 3 containing the chemically-sensitive material 8 in a preset concentration is applied to the layer 7 with the aid of a dispenser 10. The dispenser 10 can dispense the fluid in a precisely preset quantity. Normally, the quantity of the fluid 3 is between 0.1 and 10 nanoliters, e.g., about one (1) nanoliter. The resonator 2 may be an acoustic resonator made of piezoelectric material that can be excited via actuator lines 50 by an electric alternating field.

An evaluation unit 51 can be connected to the actuator lines 50 to excite the resonator 2 with its resonance frequency fR and measure the resonance frequency fR.

The distance H between the surface 6 the layer 7 and the surface 61 of the carrier 1 is a few μm. The sensor has a square base measuring about 200 μm×200 μm but can have other basic shapes, such as rectangular, round, etc. The resonator 2 may be embodied in film bulk acoustic wave resonator (FBAR) technology.

FIG. 1B shows the device 11 from FIG. 1a after the fluid 3 has been applied to the layer 7.

After the application of the fluid 3 to the surface 6 of the layer 7, the chemically-sensitive material 8 is at least partially deposited on the first layer 7, as shown in FIG. 1b. The excitation of the resonator 2 and continuous measurement of the resonance frequency fR enables the displacement of the resonance frequency fR, which is an indication of the course of the dependence of the deposition process of the chemically-sensitive material 8 on the layer. The deposition causes an increase in the overall mass of the layers 7 and 8 causing the resonance frequency to drop. In this way, it is possible to follow the deposition process virtually online. As a result it is possible, by comparison with reference values, to determine information on the quality of the layer 7 and of the deposited material 8 by measuring the temporal course of the displacement of the resonance frequency fR. In this case, quality factors of the first layer 7 are, for example, uniform covering of the resonator 2 with the layer and a constant layer thickness of the layer 7. Quality factors of the chemically-sensitive layer 8 are the uniform covering of the chemically-sensitive material 8 on the layer 7 and uniform thickness of the chemically-sensitive material 8 etc.

FIG. 1C shows the device 11 from FIGS. 1a,b after the chemically-sensitive material 8 has been uniformly distributed on the layer 7 and the fluid 3 removed, for example by heating the device 11 or by mechanical or chemical means. The device 11 is complete and hence ready for the actual measuring tasks as a sensor.

The fluid 3 from FIG. 1b may cover the entire surface 6 and does not protrude beyond the surface 6 of the resonator 2. This is achieved by combining the surfaces of the materials of the carrier 1 and the layer 7. To this end, the layer 7 has a higher affinity for the fluid 3 than the surface 61 of the carrier 1 surrounding the resonator 2 1. For example, the surface 6 of the carrier is made of gold and the surrounding surface 61 of the carrier is made of silicon dioxide SiO2. The height H of the resonator 2 or the distance of the layer 7 from the surface 61 of the carrier 1 of from a few 100 nm to a few μm supports the restriction of the fluid 3 to the surface 6 of the layer 7.

In this case, alternatively, the surface 6 of the resonator 2 facing the fluid 3 can already directly comprise a layer 7 or a relevant surface section 7 for receiving a substance to be detected and/or a reaction or mixing product to be detected or the relevant surface section 8.

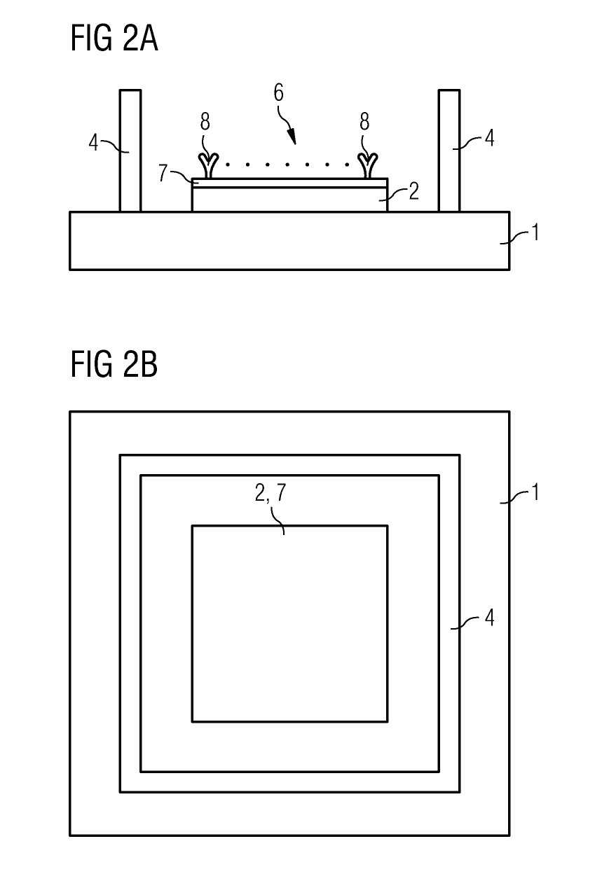

Alternatively, FIGS. 2A and 2B show in side view and top view, the device 11 from FIG. 1c with a barrier 4 surrounding the resonator 2. The barrier 4 is applied to the carrier 1 and surrounds and encloses the resonator 2, here in a square or rectangular shape. The height of the barrier 4 is higher than the distance of the surface 6 of the material of the chemically-sensitive material 8 from the surface of the carrier 1. The minimum height of the barrier 4 depends on the desired volume of the fluid 3,31 to be applied to the resonator 2.

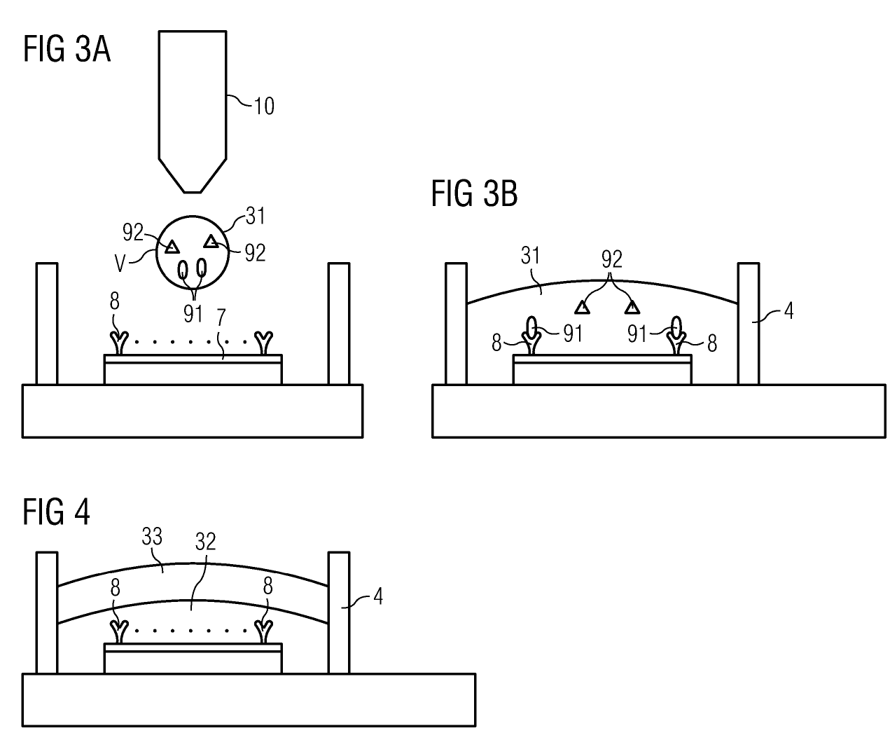

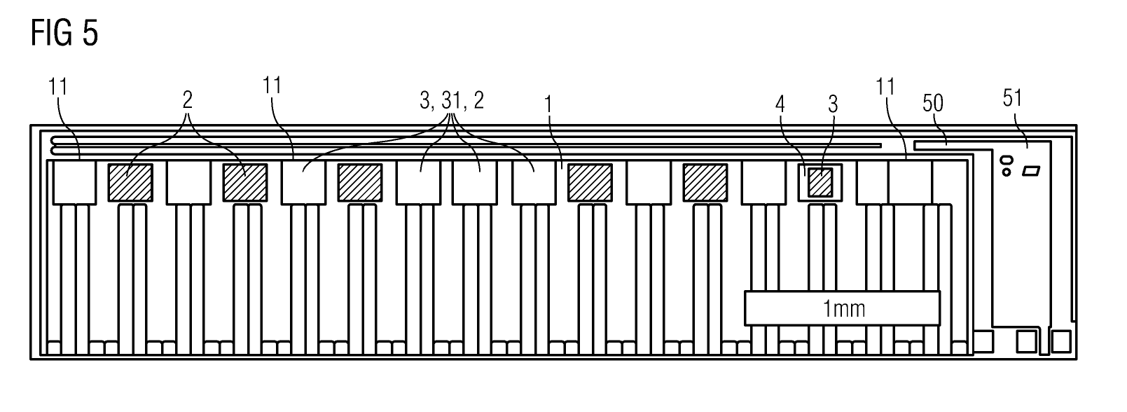

FIGS. 3A and 3B show the device 11 from FIG. 2 with successive measuring steps. The device works as a sensor 11 or measuring device for measuring the concentration of a substance 91 in a fluid 31.

Arranged above the sensor 11, there is a dispenser 10 that sprays a fluid 31 with a preset volume V onto the surface 8 of the chemically-sensitive material 8. The fluid 31 contains one or more substances 91, 92, wherein at least one of the substances 91 can bond to the chemically-sensitive material 8. Following the application of the fluid 31 to the surface 8, the substances 91 dock with the receptors of the chemically-sensitive layer 8. This results in an increase in the mass of the substances 7,8,91, located on the resonator 2 causing the resonance frequency fR of the resonator to drop. Continuous measuring of the changing resonance frequency fR enables the process of the deposition of the substances 91 on the chemically-sensitive material 8 to be continuously followed. The speed of the deposition depends upon the concentration of the substance 91, the ability of the chemically-sensitive material 8 to receive the substance 91, the temperature of the fluid 31 and various other factors.

In FIG. 3, a plurality of fluid layers 32, 33 have been applied one on top of the other on the sensor from FIG. 2A in that the dispenser 10 has applied a first fluid 32 in a first step and a second fluid 33 in a second step. The fluid types 32, 33 mix at different speeds according to the substances contained therein. The application of respective preset volumes of the corresponding fluid types 32, 33 enables a precise mixing ratio to be set without the pre-mixing usual in microfluidic technology being necessary. This enables a broad range of concentrations to be set fully automatically. In addition, in this way it is also possible to apply more than two different fluid types one on top of the other which achieves a wide range of mixing combinations.

FIG. 5 shows a row of 16 adjacent sensors 11 from FIG. 1c. Some of the sensors 11 are already covered with a fluid 3, 31 (black squares), some sensors 11 have not yet been covered with a fluid (white squares). Above the sensors 11, there are leads 50 for exciting the individual resonators 2 and for connecting the selection electronics 51. The selection electronics 51 can be integrated on the carrier 1 or connected externally. This concatenation of numerous of these sensors 11 arranged next to each other enables a large number of sensors 11 to be arranged in a matrix shape on a carrier 1.

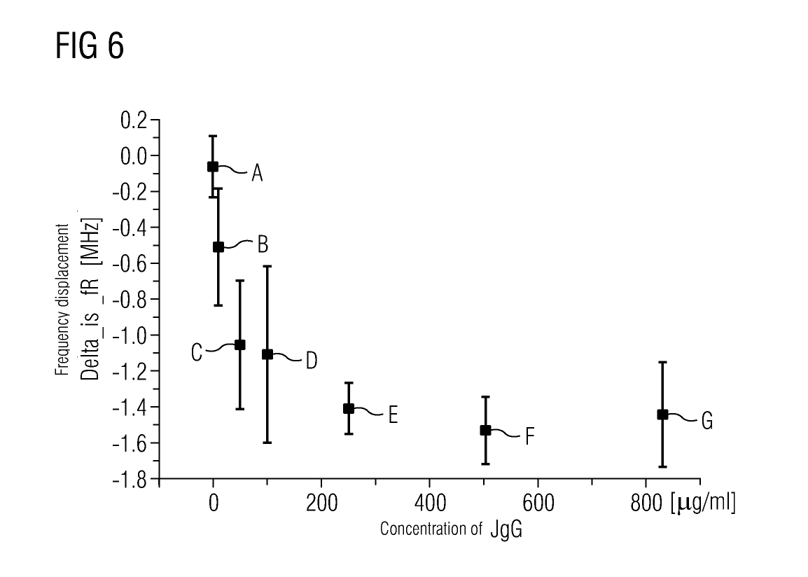

FIG. 6 shows measuring results of concentration measurements of the substance “immunoglobin” 91 in a fluid 31, which was determined with the aid of a sensor 11, from FIG. 1c or FIG. 5. To this end, in each case, preset quantities or volumes of liquid were applied with different concentrations of immunoglobin 91 to the sensors 11. The measurements could have been performed in parallel with the aid of a plurality of sensors 11 from FIG. 5 or serially one after the other with the aid of a sensor 11 from FIG. 1c, wherein the sensor 11 can be cleaned after a measurement and made available for a new measurement. In the diagram, the measured frequency displacement Delta_ist_fR [MHz] is recorded as a function of the concentration of immunoglobin [μg/ml]. The vertical bars around the respective measuring point represent the error bars. The measuring point A shows a concentration of a few μg/ml with frequency displacement of −0.05 MHz which is virtually unchanged compared to the reference value 0, i.e. liquid without immunoglobin. The measuring point B shows a concentration of about 10 μg/ml, which is already clearly measurable due to a frequency displacement of about −0.5 MHz. This shows that small changes in concentration or even small concentrations can be proven with a high degree of sensitivity. The measuring points C, D, E, F and G represent concentrations of immunoglobin of 50, 100, 250, 500 and more than 800 μg/ml with a measured frequency change Delta_ist_fR of respectively −1.05 MHz, −1.1 MHz, −1.4 MHz, −1.5 MHz, −1.5 MHz. The measuring point G with a very high concentration of more than 800 μg/ml could, for example, inter alia lead to the conclusion that the adsorption of the immunoglobin 91 on the chemically-sensitive layer of the receptors 8 from FIG. 1C is in saturation

What is claimed is:

1. A device for detecting at least one substance of a fluid or the concentration of a substance of a fluid comprising:
a carrier,
a resonator applied to the carrier, the resonator having a surface facing away from the carrier that includes a relevant surface section for at least partially receiving the substance to be detected,
wherein the surface of the resonator facing the fluid and/or the relevant surface section has a higher affinity for the fluid than the surface surrounding the resonator or the area surrounding the relevant surface section.

2. The device of claim 1, wherein the surface of the resonator comprises a first layer coated with a material that forms the relevant surface section.

3. The device of claim 1, wherein the resonator comprises a film bulk acoustic wave resonator (FBAR) and a piezoelectric element is provided as an active element of the resonator, wherein the alternating field contains a plurality of frequencies in the range of the resonance frequency simultaneously.

4. The device of claim 1, comprising an evaluation unit for evaluating the electric actuation of the resonator and for measuring the respective current resonance frequency, wherein the resonance frequency of the device is continuously excited.

5. The device of claim 1, wherein the surface of the resonator is configured to receive a liquid volume of between 0.1 and 10 nanoliters.

6. The device of claim 1, comprising a plurality of resonators arranged in a row or in an array arrangement next to each other.

7. A method for producing the device for detecting at least one substance of a fluid or the concentration of a substance of a fluid, comprising: applying a fluid containing a material to a surface of a resonator facing the fluid, such that material is at least partially deposited on the surface, and
evaluating a quality of the surface and of the deposited material following the application of the fluid by measuring a deviation of the displacement of a resonance frequency or a temporal course of the resonance frequency from a preset set point or set course.

8. The method of claim 7, wherein the resonance frequency before the application of the fluid is also used to evaluate the quality of the surface and the deposited material.

9. The method of claim 7, wherein, after the detection of a sufficient quality, removing the fluid from the surface.

10. A method for detecting at least one substance of a fluid or a reaction product of the fluid, comprising:
applying the fluid to a surface of a resonator facing the fluid,
after applying the fluid, determining at least one of: the substances, or a reaction product, or a concentration of the at least one substance or of the reaction product, or a temporal course of a deposition of the at least one substance or of the reaction product to the surface by measuring a deviation of the displacement of a resonance frequency or a temporal course of the resonance frequency from preset reference values or a set course.

11. The method of claim 10, wherein between 0.1 and 10 nanoliters of the fluid is applied to the resonator surface.

12. The method of claim 10, wherein the fluid completely covers a cross section of the surface of the resonator.

13. The method of claim 10, wherein a plurality of fluid layers are applied one on top of the other to the resonator, in that a dispensers applies a first fluid in a first step and a further fluid in a step or a plurality further steps so that the fluid types are completely mixed so that at least one of reaction products, reaction times, the mixing product, and the concentration thereof can be determined.

14. The device of claim 1, further comprising a barrier surrounding the resonator to prevent the fluid flowing off from the resonator is applied to the carrier, wherein the barrier together with the surface of the resonator encloses at least one volume for completely receiving the fluid, wherein the barrier ideally has a lower affinity for the fluid than the surface of the resonator and is preferably made of a polymer or photo-resist.
